(19) United States
(12) Patent Application Publication
(10) Pub. No.: US 2026/0295701 A1
(43) Pub. Date: Oct. 1, 2026

(54) METHOD FOR MANUFACTURING COMPONENT OF PRESSURE SENSOR

(71) Applicant: TDK CORPORATION, Tokyo (JP)

(72) Inventor: Takashi AOYAGI, Tokyo (JP)

(73) Assignee: TDK CORPORATION, Tokyo (JP)

(21) Appl. No.: 19/630,689

(22) Filed: Mar. 27, 2026

(30) Foreign Application Priority Data
Mar. 28, 2025 (JP) 2025-057278

(51) Int. Cl. B23H 9/00; G01L 9/06

(52) U.S. Cl. CPC B23H 9/00; G01L 9/06

(57) ABSTRACT

A method including a first outer cylindrical surface, a cylinder upper surface connected to upper end of the outer cylindrical surface and positioned inside in radial direction of the outer cylindrical surface, and a flange upper surface connected to lower end of outer cylindrical surface and positioned outside in radial direction of outer cylindrical surface. A main body machining step performing die sinking electrical discharge machining to metal plate from front side using electrode including a second inner cylindrical surface and bottom surface connected to lower end of the inner cylindrical surface, and bottom surface being positioned outside in radial direction of inner cylindrical surface wherein the metal plate has outer cylindrical surface facing inner cylindrical surface and flange upper surface facing bottom surface; and separating step separating main body at least including part corresponding to outer cylindrical surface and flange upper surface from metal plate using electrical discharge machining.

### CROSS-REFERENCE TO RELATED APPLICATIONS

This application claims priority to Japanese patent application No.2025-057278 filed on Mar. 28, 2025 which is incorporated herein by reference in its entirety.

### TECHNICAL FIELD

The present disclosure relates to a method for manufacturing a component of a pressure sensor which is also called a stem, or so.

### BACKGROUND

As a sensor such as a pressure sensor, a technology has been proposed which forms a detecting element made of a piezoresistive film on a surface of the component of the pressure sensor of cylindrical shape of closed end having a flange part called a stem (such as Patent Document 1).

Also, as the method for manufacturing the component of the pressure sensor, a method of grind processing or press processing a metal plate is generally used. However, in regards with the conventional manufacturing method which performs grind machining and press processing, vibrations, impacts, and heats generated during the processing are relatively large. Hence, deformation such as warpage of the component of the pressure sensor occurred as a result of influence from vibrations, impacts, heats, and so on.

### PRIOR ART DOCUMENT

### Patent Document

[Patent Document 1] JP Patent Laid Open No. H11-37877

### SUMMARY

The method for manufacturing a metal component of a pressure sensor according to the present disclosure, the component includes: a first outer cylindrical surface, a cylinder upper surface connected to an upper end of the first outer cylindrical surface and positioned inside in a radial direction of the first outer cylindrical surface, and a flange upper surface connected to a lower end of the first outer cylindrical surface and positioned outside in the radial direction of the first outer cylindrical surface; and the method including: a main body machining step performing a die sinking electrical discharge machining to a metal plate from a front side using an electrode comprising a second inner cylindrical surface and a bottom surface connected to a lower end of the second inner cylindrical surface, and the bottom surface being positioned outside in a radial direction of the second inner cylindrical surface so that the metal plate has the first outer cylindrical surface facing the second inner cylindrical surface and the flange upper surface facing the bottom surface; and a separating step separating a main body at least including a part corresponding to the first outer cylindrical surface and the flange upper surface from the metal plate using an electrical discharge machining.

### BRIEF DESCRIPTION OF DRAWINGS

FIG. 1A and FIG. 1B are conceptual figures of a component of a pressure sensor manufactured by a method for manufacturing the component of the pressure sensor according to the present disclosure.

FIG. 2A and FIG. 2B are conceptual figures showing a first step of the method for manufacturing the component of the pressure sensor according to the present disclosure.

FIG. 3A and FIG. 3B are conceptual figures showing a second step of the method for manufacturing the component of the pressure sensor according to the present disclosure.

FIG. 4 is a conceptual figure showing a third step of the method for manufacturing the component of the pressure sensor according to the present disclosure.

FIG. 5A and FIG. 5B are conceptual figures showing a fourth step of the method for manufacturing the component of the pressure sensor according to the present disclosure.

FIG. 6A and FIG. 6B are conceptual figures showing a fifth step of the method for manufacturing the component of the pressure sensor according to the present disclosure.

FIG. 7 is a conceptual figure explaining a shape of the component of the pressure sensor manufactured by the method for manufacturing the component of the pressure sensor according to the present disclosure.

FIG. 8 is a flow chart showing the method for manufacturing the component of the pressure sensor according to the present disclosure.

FIG. 9A to FIG. 9D are conceptual figures showing the method for manufacturing according to an embodiment shown in a left part of FIG. 8.

FIG. 10A to FIG. 10D are conceptual figures showing a method for manufacturing according to the first modified example.

FIG. 11A to FIG. 11D are conceptual figures showing a method for manufacturing according to the second modified example.

FIG. 12A to FIG. 12E are conceptual figures showing a method for manufacturing according to the third modified example.

FIG. 13A to FIG. 13C are conceptual figures showing a method for manufacturing according to the fourth modified example.

FIG. 14A and FIG. 14B are conceptual figures showing a method for manufacturing according to the fifth modified example.

FIG. 15 is a cross-section figure showing a condition in which the component of the pressure sensor is welded to other members using resistance welding.

FIG. 16 is a conceptual figure showing a condition of manufacturing components of the pressure sensor from one metal plate.

### DETAILED DESCRIPTION

In below, the present disclosure is described based on the embodiments shown in the figures.

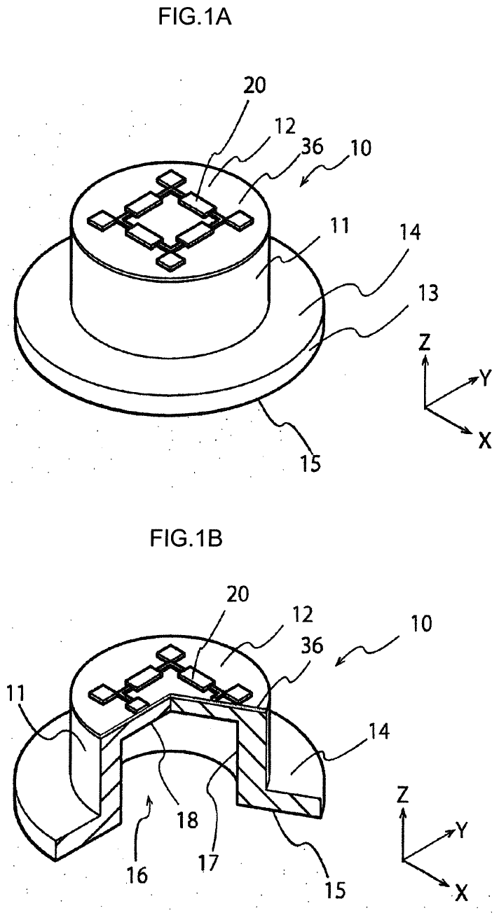

FIG. 1A is a perspective figure and FIG. 1B is a partial cross-sectional perspective figure which are an example of a component 10 of a pressure sensor manufactured by a method for manufacturing the component of the pressure sensor according to an embodiment of the present disclosure. As shown in FIG. 1A which is a perspective figure viewing from diagonally above, the component 10 of the pressure sensor includes a cylinder-shaped part and a flange part; and, the cylinder-shaped part includes a first outer cylindrical surface 11 and a cylinder upper surface 12, and the flange part includes a flange upper surface 14, a flange side surface 13, and a flange lower surface 15.

The cylinder-shaped part of the component 10 of the pressure sensor has a cylinder-like shape having a closed end, and a piezoresistive film 20 is provided via an insulation film 36 on a cylinder upper surface 12 which corresponds to an upper base surface of the cylinder shape. Note that, when the component 10 of the pressure sensor shown in FIG. 1A and FIG. 1B is viewed from a Z-axis direction, an outer circumference of the insulation film 36 overlaps with the first outer cylindrical surface 11. However, the outer circumference of the insulation film may be positioned inside in a radial direction than the first outer cylindrical surface 11, when viewing from the Z-axis direction. The first outer cylindrical surface 11 corresponds to a side surface of the cylinder shape. The cylinder upper surface 12 connects to an upper end of the first outer cylindrical surface 11, and the cylinder upper surface 12 is positioned inside in a radial direction of the first outer cylindrical surface 11. The cylinder upper surface 12 extends in a radial direction of the first outer cylindrical surface 11. Note that, the first outer cylindrical surface 11 and the cylinder upper surface 12 may be directly connected as shown in FIG. 1A and FIG. 1B. Alternatively, the first outer cylindrical surface 11 and the cylinder upper surface 12 may be connected to each other indirectly via a connecting surface having a shape whose surface faces an intermediate direction of the both surfaces such as a R-like shape or a chamfered shape.

The flange part has a ring-like shape. The flange upper surface 14 is an upper surface of the flange part which connects to a lower end of the first outer cylindrical surface 11, and the flange upper surface 14 is positioned outside in a radial direction of the first outer cylindrical surface 11. The flange upper surface 14 extends in a radial direction of the first outer cylindrical surface 11. The flange side surface 13 configures a side circumference which defines the outer circumference edge of the flange part, and the flange lower surface 15 configures a lower surface of the flange part. Note that, the first outer cylindrical surface 11 and the flange upper surface 14 may directly connect with each other as shown in FIG. 1A and FIG. 1B. Alternatively, the first outer cylindrical surface 11 and the flange upper surface 14 may connect to each other indirectly via a connecting surface having a shape whose surface faces an intermediate direction of the both surfaces such as a R-like shape or a chamfered face.

As shown in FIG. 1B which is a partial cross-sectional perspective figure of the component 10 of the pressure sensor, a cavity 16 is formed inside the cylinder-shaped part of the component 10 of the pressure sensor. The cavity 16 is a hole having a circular column-like shape, and a cavity side surface 17 surrounds the cavity in a circumferential direction. The cavity 16 configures a space that an upper side is covered by a cavity upper surface 18, and the lower side of the cavity 16 is an open end.

The cylinder upper surface 12 and the flange upper surface 14 are surfaces facing up, and the first outer cylindrical surface 11 and the flange side surface 13 are surfaces facing outside in the radial direction (outside in a radius direction of the cylinder shape). The flange lower surface 15 and the cavity upper surface 18 are surfaces facing down, and the cavity side surface 17 is a surface facing inside in the radial direction (inside in a radius direction of the cylinder shape).

For explaining the component 10 of the pressure sensor and the method for manufacturing the component 10 of the pressure sensor, a height direction of the cylinder-shaped part is defined as a up/down direction or a Z-axis direction, and directions perpendicular to each other and also perpendicular to Z-axis are respectively defined as an X-axis direction and a Y-axis direction. Also, a surface which a normal direction is facing the Z-axis positive direction is referred to as an upper surface or a front surface, and the surface facing the Z-axis negative direction is referred to as a lower surface or back surface.

In the component 10 of the pressure sensor, a cavity upper surface 18 becomes a pressure-receiving surface, and the cylinder upper surface 12 deforms in response to the pressure of the cavity 16. In the pressure sensor using the component 10 of the pressure sensor, the deformation of the cylinder upper surface 12 is detected by a piezoresistive film 20 provided on the cylinder upper surface 12, and the pressure of the cavity 16 is calculated from the detected value obtained by the piezoresistive film 20.

Materials of the component 10 of the pressure sensor is made from, for example, metals such as stainless steel. Note that, the materials of the component 10 of the pressure sensor are not limited to stainless steel, and the component 10 of the pressure sensor can be manufactured using any metal materials which can be machined using an electrical discharge machining.

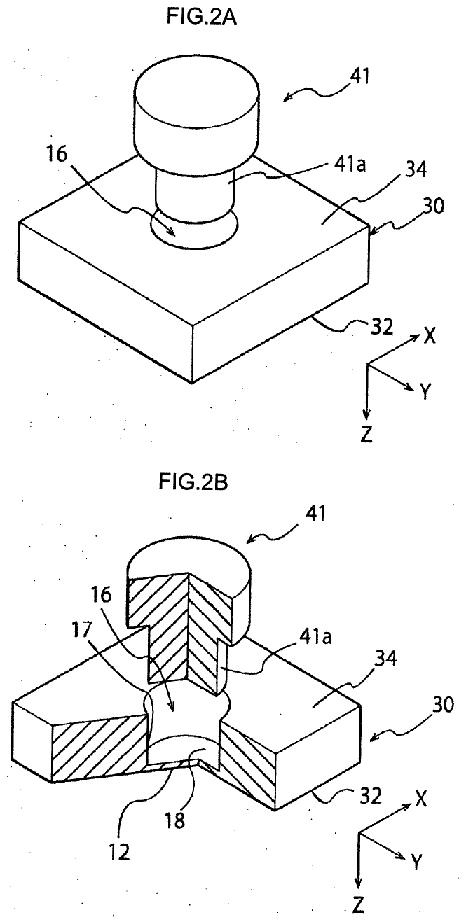

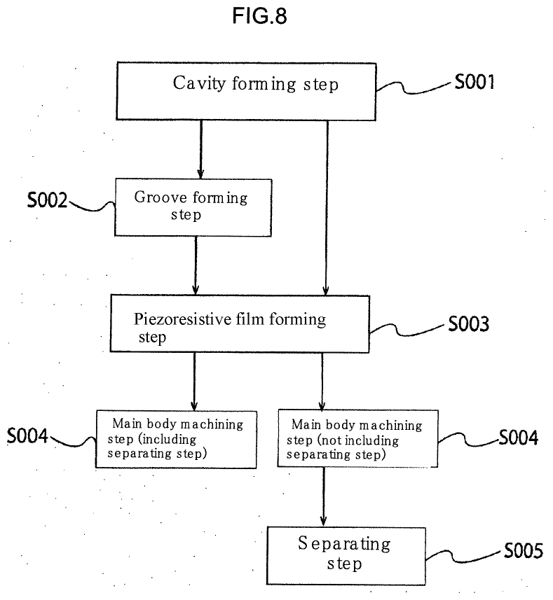

FIG. 2A to FIG. 6B are conceptual figures showing each manufacturing step of the method for manufacturing the component of the pressure sensor according to the present disclosure. FIG. 8 is a flow chart showing the method for manufacturing the component of the pressure sensor shown in FIG. 2A to FIG. 6B. Below describes one example of the method for manufacturing the component 10 of the pressure sensor shown in FIG. 1A and FIG. 1B by mainly using FIG. 2A to FIG. 6B and FIG. 8.

As shown in FIG. 8, the method for manufacturing the component of the pressure sensor has a cavity forming step (Step S001), a groove forming step (Step S002), a piezoresistive film forming step (Step S003), a main body machining step (Step S004), and a separating step (Step S005). Note that, each step shown in FIG. 8 (Step S001 to Step S005) can be carried out in the order shown in FIG. 8. Alternatively, the steps can also be performed in different order from that shown in FIG. 8. Also, FIG. 8 shows that there are two methods for manufacturing in regards with the steps after the cavity forming step (Step S001). That is, as shown in the left part of FIG. 8, by carrying out the groove forming step (Step S002), the main body machining step (Step S004) which is in the later step consequently includes the separating step; hence, the separating step (Step S005) using a wire electrical discharge machining can be skipped. Further, as shown in the right part of FIG. 8, the groove forming step S002 may be skipped and the piezoresistive film forming step (Step S003) may be carried out. In such case, as discussed later, the separating step (Step S005) using a wire electrical discharge machining is carried out after the main body machining step (Step S004).

Also, the piezoresistive film 20 formed in the step S003 is part of the pressure sensor; however, it does not necessarily have to be included in the component 10 of the pressure sensor itself. As shown in FIG. 8, the piezoresistive film forming step (Step S003) can be performed before the main body machining step (Step S004) of the component 10 of the pressure sensor, and it may also be performed before or after the other steps. Further, the piezoresistive film 20 may be formed on a metal plate 30 (see FIG. 2A and FIG. 2B) which becomes the raw material of the component of the pressure sensor, prior to all of the steps except for the piezoresistive film forming step included in the method for manufacturing the component of the pressure sensor. Further, it may also be formed to singulated components 10 of the pressure sensor after all of the steps except for the piezoresistive film forming step included in the method for manufacturing the component of the pressure sensor.

FIG. 2A and FIG. 2B are conceptual figures showing the cavity forming step which is the first step (Step S001 of FIG. 8) of the method for manufacturing the component of the pressure sensor according to the present disclosure. FIG. 2A is a perspective figure viewing a first electrode 41 and a back surface 34 of the metal plate 30 used in the cavity forming step (Step S001), from a diagonal direction. FIG. 2B is a partial cross-section of the FIG. 2A.

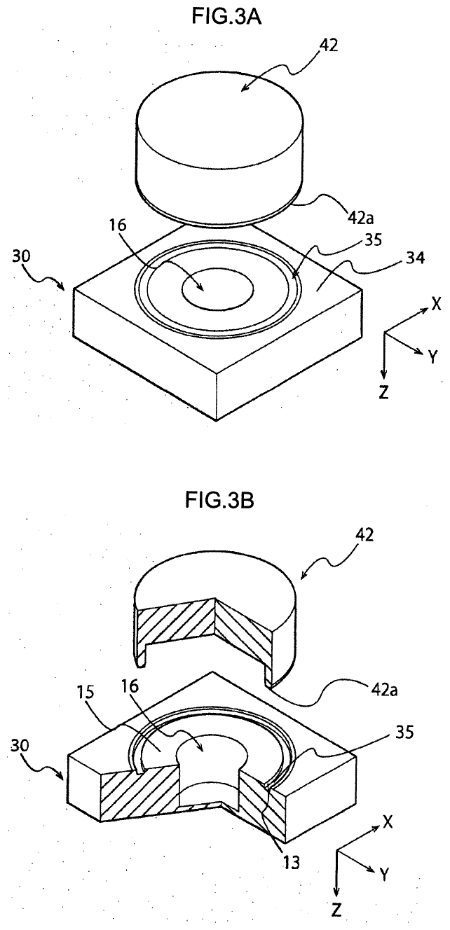

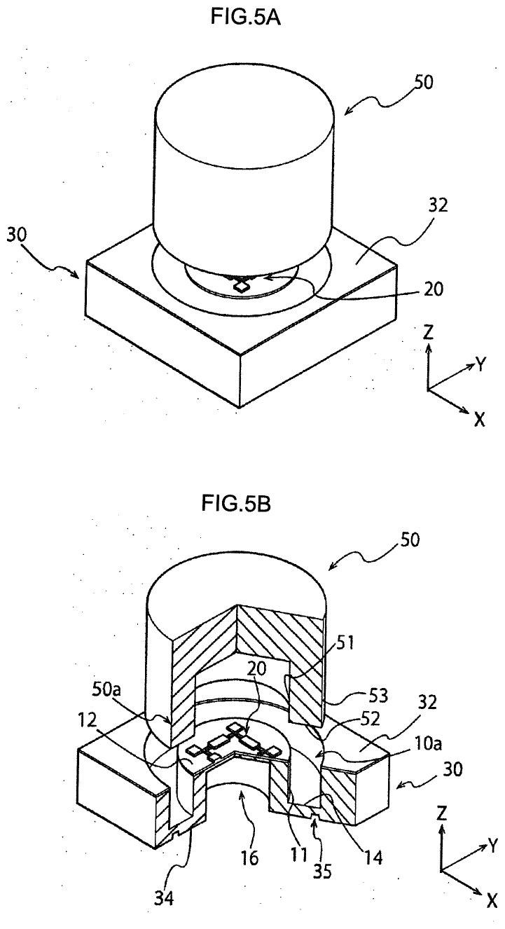

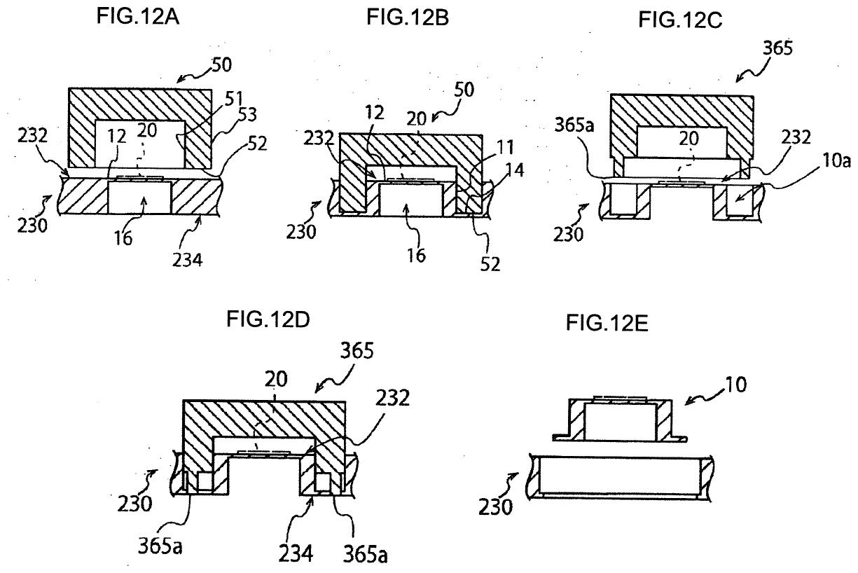

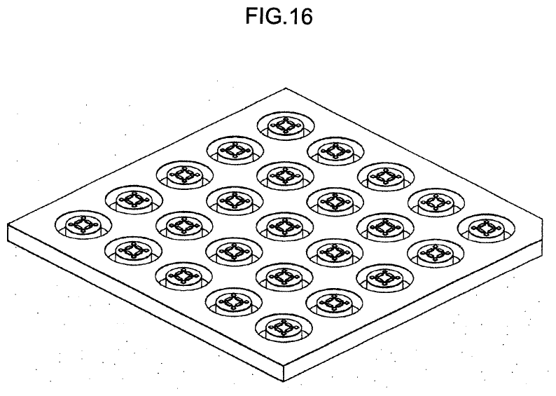

As shown in FIG. 2A and FIG. 2B, for the method for manufacturing the component of the pressure sensor, the metal plate 30, which is the raw material of the component of the pressure sensor, is prepared. As the metal plate 30, the flat plate-shaped metal plate such as shown in FIG. 2A and FIG. 2B can be used. A thickness of the metal plate 30 (width in the Z-axis direction) may be the same as the height of the component 10 of the pressure sensor which is to be manufactured. Note that, in order to simplify the explanation, FIG. 2A to FIG. 6B show the conditions of manufacturing one component 10 of the pressure sensor from one metal plate 30; however, the components of the pressure sensor may be manufactured from one metal plate according to the method for manufacturing the component 10 of the pressure sensor of the present disclosure (see FIG. 16). By manufacturing the components 10 of the pressure sensor from one metal plate, many components 10 of the pressure sensor can be produced efficiently. Also, in the case of manufacturing the components of the pressure sensor from one metal plate as shown in FIG. 16, similar electrodes are arranged (such as the first electrode 41 shown in FIG. 2A and FIG. 2B), and a die sinking electrical discharge machining may be performed simultaneously using the electrodes. As discussed later, the same applies to a second electrode 42 (FIG. 3A and FIG. 3B), a third electrode 50 (FIG. 5A and FIG. 5B), and a fourth electrode 365 (FIG. 12A to FIG. 12E).

As shown in FIG. 2A and FIG. 2B, in the cavity forming step (Step S001), the die sinking electrical discharge machining is performed to the metal plate 30 from the back surface 34 side of the metal plate 30. Thereby, in the cavity forming step, the cavity 16 having a circular column-like shape is formed to the back surface 34 of the metal plate 30 (see FIG. 2B and FIG. 1B).

For the die sinking electrical discharge machining of the cavity forming step, the first electrode 41 as shown in FIG. 2A and FIG. 2B is used to perform the die sinking electrical discharge machining to the metal plate 30. That is, as shown in FIG. 2A and FIG. 2B, the first electrode 41 has a circular column-like part 41a which corresponds to the circular column-like shape of the cavity 16. During the die sinking electrical discharge machining of the cavity forming step, the metal plate 30 facing the bottom surface and the side surface of the circular column-like part 41a of the first electrode 41 is melted/removed. Thereby, the cavity 16 having a shape corresponding to the circular column-like part 41a of the first electrode 41 is formed to the metal plate 30.

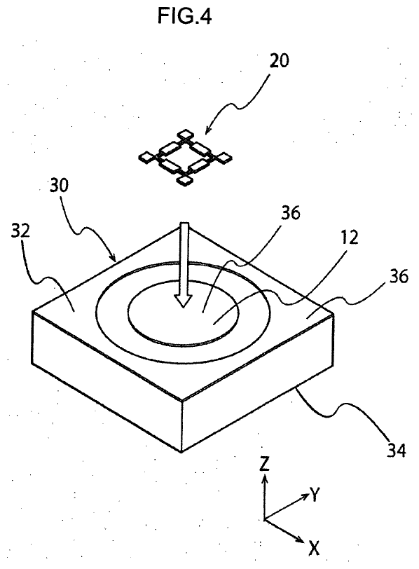

As it is discussed in the section explaining the main body machining step (Step S004, FIG. 4), the die sinking electrical discharge machining in the cavity forming step is performed to the back surface 34 at the position which becomes the cylinder upper surface 12 of the front surface 32 of the metal plate 30.

Materials of the first electrode 41 used for the die sinking electrical discharge machining of the cavity forming step (Step S001) are not particularly limited, and examples include copper, graphite, and tungsten. Also, examples of a machining fluid present around the first electrode 41 and the metal plate 30 as an object to be machined by the die sinking electrical discharge machining include an ion-exchange water, and oils containing paraffin-based hydrocarbons. However, it is not limited to these. Also, the die sinking electrical discharge machining may be performed by PECM (PRECISION ELECTROCHEMICAL MACHINING) using an electrolytic solution as a machining fluid which include electrolytes such as NaNO₃ or NaCl. The die sinking electrical discharge machining which performs machining within the fluid exhibits an excellent heat dissipation property.

Further, as shown in the left part of FIG. 8, the groove forming step (Step S002) is performed after the cavity forming step. FIG. 3A and FIG. 3B are the conceptual figures showing the groove forming step which is the second step of the method for manufacturing the component of the pressure sensor. FIG. 3A is a perspective figure viewing, from the diagonal direction, the second electrode 42 and the back surface 34 of the metal plate 30 used in the groove forming step (Step S002). FIG. 3B is a partial cross-section of the FIG. 3A.

As shown in FIG. 3A and FIG. 3B, during the groove forming step (Step S002), the object to be machined is the metal plate 30 to which the cavity 16 has been formed by the cavity forming step (Step S001). Note that, the groove forming step (Step S002) may be carried out before the cavity forming step (Step S001), and the cavity forming step (Step S001) may be carried out after the groove forming step. Also, the groove forming step (Step S002) is performed before the main body machining step (Step S004).

As shown in FIG. 3A and FIG. 3B, during the groove forming step (Step S002), as similar to the cavity forming step (Step S001), the die sinking electrical discharge machining is performed to the metal plate 30 from the back surface 34 side of the metal plate 30. Thereby, in the groove forming step, the groove 35 having a ring shape is formed to the back surface 34 of the metal plate 30 (see FIG. 3A and FIG. 3B).

For the die sinking electrical discharge machining of the groove forming step, the second electrode 42 such as shown in FIG. 3A and FIG. 3B is used to perform the die sinking electrical discharge machining to the metal plate 30. That is, as shown in FIG. 3B, the second electrode 42 has a ring-like protrusion 42a which corresponds to the ring shape of the groove 35. During the die sinking electrical discharge machining of the cavity forming step, the metal plate 30 facing the ring-like protrusion 42a of the second electrode 42 is melted/removed. Thereby, the groove 35 having a shape corresponding to the ring-like protrusion 42a of the second electrode 42 is formed to the metal plate 30. Note that, a part of the groove 35 may be a part of the flange side surface 13 of the component 10 for the pressure sensor shown in FIG. 1A and FIG. 1B.

As shown in FIG. 3A and FIG. 3B, the die sinking electrical discharge machining in the groove forming step is performed to an area around the position where the cavity 16 is formed on the back surface 34 of the metal plate 30. Thereby, the groove 35 having a ring shape which is formed during the groove forming step (Step S002) surrounds the outer circumference of the opening edge of the cavity 16, and the groove 35 and the opening edge of the cavity 16 are formed approximately concentrically.

As the materials and the machining fluid of the second electrode 42 used for the die sinking electrical discharge machining in the groove forming step (Step S002), the fluid may be the same as those mentioned in the section explaining the machining fluid of the first electrode 41 of the cavity forming step (Step S001).

Further, as shown in the left part of FIG. 8, the piezoresistive film forming step (Step S003) is performed after the groove forming step. Further, as shown in the right side of FIG. 8, the groove forming step may be skipped and the piezoresistive film forming step may be performed after the cavity forming step. FIG. 4 is a conceptual figure showing the piezoresistive film forming step which is the third step of the method for manufacturing the component of the pressure sensor. In the piezoresistive film forming step (Step S003), unlike the cavity forming step (Step S001) and the groove forming step (Step S002), a thin-film forming step and the like are performed to the front surface 32 of the metal plate 30.

As shown in FIG. 8, the piezoresistive film forming step can be performed before the main body machining step (Step S004). By carrying out the piezoresistive film forming step before the main body machining step (Step S004), the piezoresistive film forming step which includes a thin-film forming step, etc., can be performed to the front surface 32 of the flat metal plate 30 which is relatively easy to form a film. Thus, in the case of manufacturing for the components of the pressure sensor from one metal plate, piezoresistive film patterns corresponding to the components of the pressure sensor can be formed at the same time; thus, the piezoresistive film can be formed efficiently.

As shown in FIG. 4, in the piezoresistive film forming step (Step S003), an insulation film 36 is formed on the front surface 32 of the metal plate 30, and the piezoresistive film 20 is formed on the insulation film 36 formed on the front surface 32. The piezoresistive film 20 is formed at the position which becomes the cylinder upper surface 12 (see FIG. 1A ad FIG. 1B) on the front surface 32 of the metal plate 30. Note that, the outer circumference part of the position which becomes the cylinder upper surface 12 (see FIG. 1A and FIG. 1B) is the position to be machined (corresponds to the flange upper surface 14 when viewing from the Z-axis direction) during the main body machining step (Step S004). Thus, the insulation film 36 is not formed on such part of the front surface 32 of the metal plate 30. A width of belt-like part where the insulation film 36 is not formed is wider than a distance in a radial direction between the second inner cylindrical surface 51 and the second cylindrical outer surface 53 of the third electrode 50 which is discussed later.

The piezoresistive film forming step is performed using a thin-film forming step which is used for forming insulation films, conductive films, piezoresistive films, etc. During the piezoresistive film forming step, a thin-film forming step and a fine machining step such as deposition, spattering, screen printing, and etching are used appropriately to form the piezoresistive film 20 which detects the deformation of the cylinder upper surface 12 by the change in a resistance value.

As shown in FIG. 8, the piezoresistive film forming step (Step S003) is performed after the main body machining step (Step S004). FIG. 5A and FIG. 5B are the conceptual figures showing the main body machining step which is the fourth step of the method for manufacturing the component of the pressure sensor. FIG. 5A is a perspective figure viewing from the diagonal direction of the third electrode 50 used in the main body machining step (Step S004) and the front surface 32 of the metal plate 30 which is the object to be machined. FIG. 5B is a partial cross section of the third electrode 50 and the metal plate 30 after the main body machining step (Step S004).

As shown in FIG. 5A and FIG. 5B, regarding the main body machining step (Step S004), the object to be machined is the metal plate 30 to which the piezoresistive film 20 has been formed on the front surface 32 of the metal plate 30 during the piezoresistive film forming step (Step S003). Also, to the back surface 34 of the metal plate 30 which is the object to be machined during the main body machining step (Step S004), the cavity 16 and the groove 35 are formed by the cavity forming step and the groove forming step.

In the main body machining step (Step S004), unlike the cavity forming step (Step S001) and the groove forming step (Step S002), a die sinking electrical discharge machining is performed to the metal plate 30 from the front surface 32 side of the metal plate 30 which is the object to be machined.

For the die sinking electrical discharge machining of the main body machining step, the third electrode 50 such as shown in FIG. 5A and FIG. 5B is used to perform the die sinking electrical discharge machining to the metal plate 30. That is, as shown in FIG. 5B, the third electrode 50 includes the second inner cylindrical surface 51 and the bottom surface 52 which connects to the lower end of the second inner cylindrical surface 51, and the bottom surface 52 being positioned outside of the second inner cylindrical surface 51 in the radial direction. The bottom surface 52 extends in the radial direction of the second inner cylindrical surface 51. Also, the third electrode 50 includes the second outer cylindrical surface 53 positioned outside of the second inner cylindrical surface 51 in the radial direction. In the third electrode 50, the bottom surface 52 connects to the lower end of the second outer cylindrical surface 53. That is, in the third electrode 50, the second inner cylindrical surface 51 is deemed an inner wall surface, and the second outer cylindrical surface 53 is deemed an outer wall surface. The third electrode 50 includes a ring-like protruding part 50a which the bottom surface 52 is a lower end surface.

During the die sinking electrical discharge machining of the main body machining step, the metal plate 30 facing each of the surfaces 51, 52, and 53 of the ring-like protruding part 50a of the third electrode 50 is melted/removed. Thereby, the shape corresponding to the ring-like protruding part 50a of the third electrode 50 is formed to the metal plate 30. That is, as shown in FIG. 5B, in the main body machining step (Step S004), the first outer cylindrical surface 11 facing the second inner cylindrical surface 51 of the third electrode 50 is formed to the metal plate 30. Also, during the main body machining step (Step S004), the flange upper surface 14 facing the bottom surface 52 of the third electrode 50 is formed to the metal plate 30.

As shown in FIG. 5B, due to the die sinking electrical discharge machining in the main body machining step, the main body 10a which includes the first outer cylindrical surface 11, the flange upper surface 14, etc., are formed. Note that, in the example shown in FIG. 5B, the main body 10a includes the cylinder upper surface 12, the cavity 16, etc.

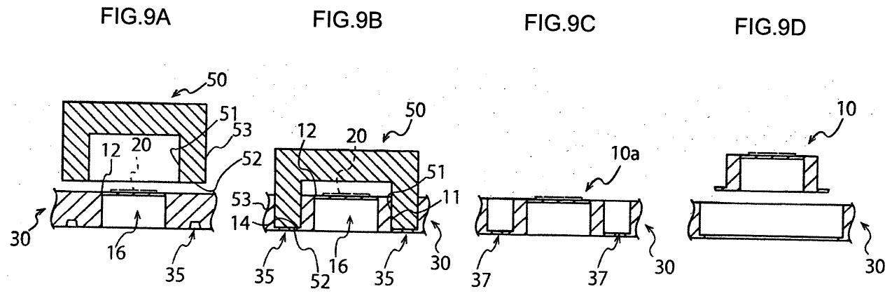

Also, in the main body machining step (including the separating step) (Step S004, the left side of FIG. 8) shown in FIG. 5A and FIG. 5B, due to the die sinking electrical discharge machining performed using the third electrode 50 from the front surface 32 side of the metal plate 30, a penetrating part is formed from the front surface 32 to the back surface 34 of the metal plate 30, and the penetrating part connects to the groove 35. By performing such main body machining step, the separating step (S005) itself can be carried out together with the main body machining step. Thus, the production steps can be simplified. That is, by performing the groove forming step (Step S002) prior to the main body machining step (Step S004), the main body 10 a (see FIG. 9A to FIG. 9D) can be separated from the metal plate 30 during the main body machining step (Step S004). Thus, the separating step (Step S005) using the wire electrical discharge machining can be skipped.

In FIG. 9A to FIG. 9D, the main body machining step (including the separating step) (Step S004) according to the embodiment shown in the left part of FIG. 8 are shown in further detail. FIG. 9A to FIG. 9D are the conceptual figures showing the metal plate 30, which is an object to be machined, and the third electrode 50 during the main body machining step (including the separating step) (Step S004) according to the embodiment shown in the left part of FIG. 8.

FIG. 9A which is the first state of the main body machining step (Step S004) shows cross sections of the third electrode 50 and the metal plate 30 prior to machining using the third electrode 50 (see FIG. 5A for the perspective figure). Next, as shown in FIG. 9B as the second state, in the main body machining step (Step S004) of the method for manufacturing according to the embodiment (the left part of FIG. 8), the lower end of the third electrode 50 reaches the groove 35. Thereby, in the main body machining step (including the separating step), due to the die sinking electrical discharge machining performed from the front side of the metal plate 30 using the third electrode 50, a penetrating part 37 is formed from the front surface 32 side of the metal plate 30 and connects to the groove 35.

As understood from FIG. 9C showing the metal plate 30 which is after the machining by the third electrode 50 (the third state), in the main body machining step according to the embodiment (the left part of FIG. 8), due to the main body machining step which machines from the front surface 32 side of the metal plate 30 (continuously from the main body machining step for forming the penetrating part 37), the main body 10a is separated from the metal plate 30. That is, the main body machining step using the third electrode 50 used in the embodiment (the left part of FIG. 8) can concurrently perform the separating step which separates the main body 10a from the metal plate 30. FIG. 9D shows the fourth step which the main body 10a after the separating step is being taken out.

As shown by the method for manufacturing according to the embodiment shown in the left side of FIG. 8, the separating step itself can be concurrently performed with the main body machining step (Step S004) as shown in FIG. 9A to FIG. 9D. Thus, the manufacturing steps can be simplified. Also, by using the method for manufacturing according to the embodiment shown in the left part of FIG. 8, for example, during the main body machining step, while keeping the back surface 34 of the metal plate 30 fixed using a bonding component such as a both-sided adhesive tape, the die sinking electrical discharge machining can be performed from the front side of the metal plate 30. Also, when the materials of the metal plate 30 is a ferromagnetic body, while keeping the metal plate 30 fixed using magnets such as electromagnet from the back surface 34 side of the metal plate 30, the die sinking electrical discharge machining can be performed from the front side surface of the metal plate 30. In such case, by using the method for manufacturing according to the embodiment shown in the left part of FIG. 8, when the main body 10a is separated from the metal plate 30 by forming the penetrating part 37, the separated main body 10a and the metal plate 30 can be fixed stably.

Further, as shown in the right part of FIG. 8, when the groove forming step (Step S002) is not performed, the main body 10a is not separated during the main body machining step (not including the separating step) (Step S004) (the right part of FIG. 8).

As the materials and the machining fluid of the third electrode 50 used for the die sinking electrical discharge machining of the main body machining step (Step S004), it may be the same as those mentioned in the section explaining the machining fluid of the first electrode 41 of the cavity forming step (Step S001).

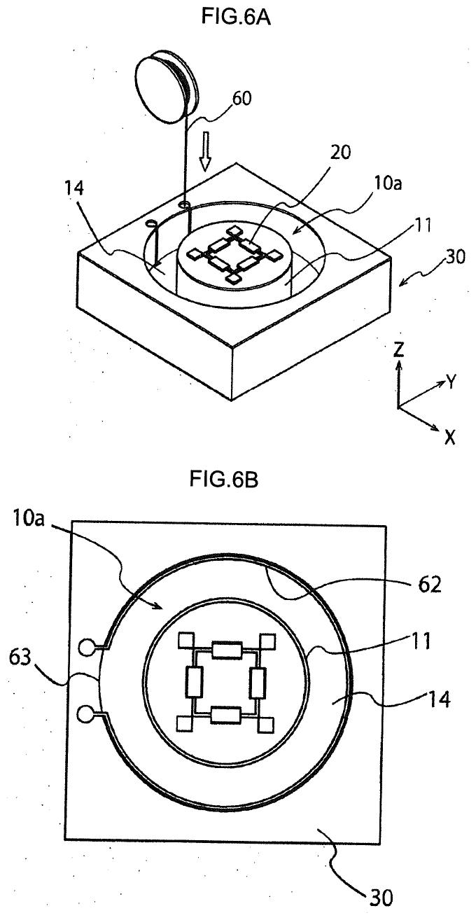

As shown in the right part of FIG. 8, when the groove forming step (Step S002) is not performed, the separating step (Step S005) is performed after the main body machining step (Step S004). FIG. 6A and FIG. 6B are the conceptual figures showing the separating step which are the fifth step of the method for manufacturing the component of the pressure sensor. FIG. 6A is a perspective figure, viewing from the diagonal direction, of the wire 60 used in the separating step (Step S005) and the front surface 32 side of the metal plate 30 as the object to be machined. FIG. 6B is a plan view showing a cutting path 62 when the metal plate 30 is cut by the wire 60 in the separating step (Step S005).

As shown in FIG. 6A and FIG. 6B, in the separating step (Step S005), the main body 10a machined during the main body machining step (Step S004) and the like is separated from the metal plate 30 by the electrical discharge machining. As shown in FIG. 6A, the main body 10a separated during the separating step is a part which configures the component 10 of the pressure sensor shown in FIG. 1A and FIG. 1B. The main body 10a at least includes the first outer cylindrical surface 11 and the flange upper surface 14 formed to the metal plate 30 during the main body machining step (Step S004). Also, the main body 10a includes the cylinder upper surface 12, the cavity 16, etc.

As shown in FIG. 6A and FIG. 6B, the separating step (Step S005) can be performed using the wire electrical discharge machining after the main body machining step. In the separating step using the wire electrical discharge machining, first, a penetration hole penetrating the metal plate 30 in the Z-axis direction is formed in a pre-step, as it is shown in FIG. 6A. Then, the wire 60 is passed through the penetration hole, and the wire 60 is set to penetrate the metal plate 30 in the Z-axis direction.

Further, the wire 60 penetrating the metal plate 30 in the Z-axis direction is moved in relative to the metal plate 30 along the cutting path 62 (and a second cutting path 63) which is made along the outer circumference edge of the flange upper surface 14 as shown in FIG. 6B. Thereby, the main body 10a is separated from the metal plate 30.

Note that, the separating step using the wire electrical discharge machining can be performed in two steps as shown in FIG. 6B. That is, in the first separating step, the wire 60 moves along the cutting path 62, and most of the outer circumference edge of the flange upper surface 14 is cut while leaving very small connecting part. Next, in the second separating step, the wire 60 moves along the second cutting path 63 to cut the remaining connecting part. Thereby, the main body 10a is separated from the metal plate 30. Note that, between the first separating step and the second separating step, a tape, a magnet (the magnet is used when the metal plate is ferromagnetic material), or so is arranged on the back surface of the metal plate 30 for preventing the main body 10a from falling off while separating. Further, such tape, magnet, or so is arranged on the back surface of the metal plate 30 so as to encompass the part which forms the main body 10a and the other part of the metal plate 30, but such tape, magnet, or so is not arranged to the second cutting path 63. By performing the separating step in two steps as such, the main body 10a and the other part separated from the main body 10a can be both held appropriately in a simple structure.

Materials of the wire 60 used for the wire electrical discharge machining of the separating step (Step S005) are not particularly limited, and examples include CuZn alloy. Also, examples of the machining fluid used during the wire electrical discharge machining include an ion-exchange water, and oils containing paraffin-based hydrocarbons. However, it is not limited to these. Note that, as mentioned in above, the separating step can be performed using the die sinking electrical discharge machining instead of using the wire electrical discharge machining (see the first to third modified examples). Also, in the case that the separating step is performed using the wire electrical discharge machining, the groove forming step (Step S002) shown in FIG. 8 may be performed.

In the method for manufacturing the component of the pressure sensor according to the present disclosure, the component 10 of the pressure sensor shown in FIG. 1A and FIG. 1B is manufactured using the method shown in FIG. 8. Such method for manufacturing the component of the pressure sensor includes the main body machining step (Step S004) which is done by the die sinking electrical discharge machining using the third electrode 50 having a predetermined shape. Thus, vibrations, impacts, heats, and so on during the machining of the main body machining step can be reduced effectively. Also, by performing the separating step using the electrical discharge machining, vibrations, impacts, heats, and so on during the machining of the separating step can be reduced effectively.

Also, by performing the cavity forming step (Step S001) using the die sinking electrical discharge machining, vibrations, impacts, heats, and so on during the machining can be reduced effectively. Also, by forming the piezoresistive film 20 to the metal plate 30 during the piezoresistive film forming step before the main body machining step (Step S004), the piezoresistive film 20 can be formed efficiently at the position corresponding to the cylinder upper surface 12. Thus, the manufacturing steps can be simplified. Also, the main body machining step and the separating step performed after forming the piezoresistive film 20 are performed using the electrical discharge machining; thereby, vibrations, impacts, heats, and so on during the main body machining step and the separating step can be reduced effectively from propagating to the piezoresistive film 20. Hence, damages to the piezoresistive film 20 can be reduced effectively.

Also, among the methods for manufacturing the component of the pressure sensor mentioned in above, the method shown in the right part of FIG. 8 performs the separating step (Step S005) using the wire electrical discharge machining. In such separating step, by controlling the relative movement of the wire 60, it is possible to appropriately control the timing of separating the main body 10a from the metal plate 30.

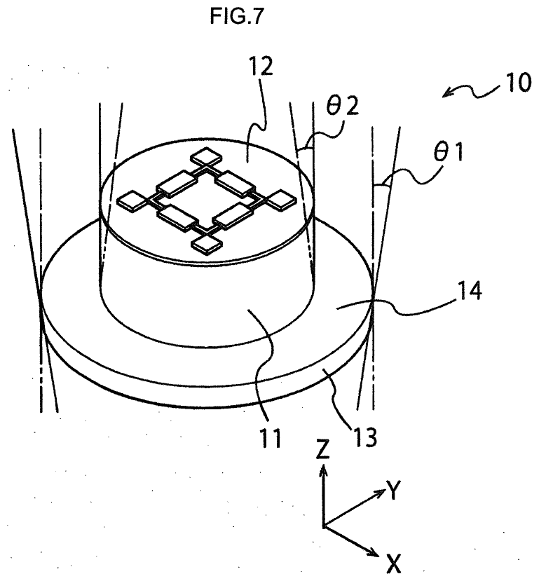

Also, according to the method for manufacturing the component of the pressure sensor shown in FIG. 2A to FIG. 6B and FIG. 8 to FIG. 9D, the shape of the component 10 of the pressure sensor shown in FIG. 1A and FIG. 1B can be set/change more freely compared to the case of using the press machining. For example, regarding the component 10 of the pressure sensor manufactured using the method for manufacturing the component of the pressure sensor shown in FIG. 2A to FIG. 6B and FIG. 8, FIG. 7 shows a conceptual figure explaining that the angle of the flange side surface 13 and the first outer cylindrical surface 11 can be changed.

As shown in FIG. 7, an inclination angle θ1 which is the angle of the flange side surface 13 with respect to the Z-axis direction can be changed relatively easily by adjusting the angle of the wire 60 during the separating step (Step S005) shown in FIG. 6A and FIG. 6B and by adjusting the shape of the second electrode 42 during the groove forming step (Step S002). Also, as shown in FIG. 7, an inclination angle θ2 of the first outer cylindrical surface 11 with respect to the Z-axis direction can be easily set to any angle by adjusting the shape of the third electrode 50 used in the main body machining step (Step S004). Also, an inclination angle of the cavity side surface 17 with respect to the Z-axis direction can be easily set to any angle by adjusting the shape of the first electrode 41 used in the cavity forming step (Step S001).

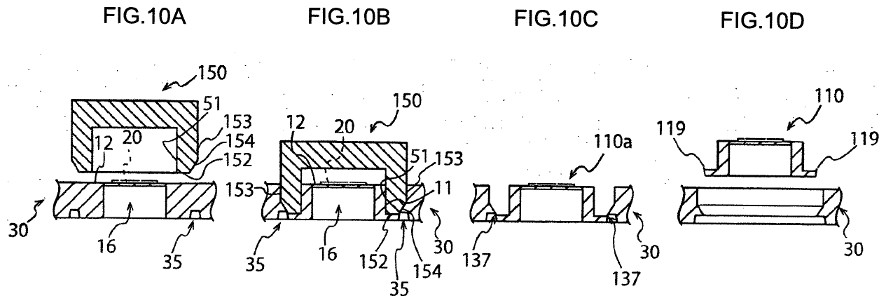

FIG. 10A to FIG. 10D are the conceptual figures showing the first modified example of the method for manufacturing the component of the pressure sensor according to the present disclosure. The method for manufacturing according to the first modified example is basically the same as the method for manufacturing shown in FIG. 9A to FIG. 9D; however, a third electrode 150, etc., used in the main body machining step (including the separating step) (Step S004) are different from the method for manufacturing shown in FIG. 9A to FIG. 9D. FIG. 10A to FIG. 10D are the conceptual figures showing the third electrode 150 and the metal plate 30 which is an object to be machined used in the main body machining step (Step S004) of the method for manufacturing according to the first modified example.

As shown in FIG. 10A which is the first state of the main body machining step (Step S004), the third electrode 150 used in the main body machining step according to the first modified example has a bottom surface 152 which connects to a second outer cylindrical surface 153 via a connecting surface 154 at the lower end of the second outer cylindrical surface 153. For example, the connecting surface 154 has an R-shape or a chamfered shape. Further, the metal plate 30 which is the object to be machined during the main body machining step (Step S004) is the same as the metal plate 30 according to the embodiment shown in FIG. 9A.

Next, as shown in FIG. 10B which is the second state, in the main body machining step (Step S004) of the method for manufacturing according to the first modified example, the connecting surface 154 of the third electrode 150 reaches the groove 35. Thereby, in the main body machining step of the first modified example, due to the die sinking electrical discharge machining performed from the front surface 32 side of the metal plate 30 using the third electrode 150, and a penetrating part 137 is formed from the front surface 32 of the metal plate 30 and connects to the groove 35.

As understood from FIG. 10C showing the metal plate 30 which is after the machining using the third electrode 150 (the third state), in the main body machining step according to the first modified example, due to the main body machining step machining from the front surface 32 side of the metal plate 30 (continuously from the main body machining step for forming the penetrating part 137), a main body 110a is separated from the metal plate 30. That is, the main body machining step using the third electrode 150 in the first modified example can concurrently perform the separating step which separates the main body 110a from the metal plate 30. FIG. 10D shows the fourth step which shows the main body 110a after the separating step being taken out.

Also, as shown in FIG. 10D, in the component 110 of the pressure sensor obtained using the method for manufacturing according to the first modified example, a flange outer circumference inclined surface 119 is formed at the position facing the connecting surface 154 of the third electrode 150. The flange outer circumference inclined surface 119 configures the ring-like protruding part formed along the outer circumference edge of the flange upper surface 14. At least part of such flange outer circumference inclined surface 119 suitably functions as a welding margin when the flange part of the pressure sensor is fixed to the other components using the resistance welding in later stage. Therefore, according to such method for manufacturing, the component 110 of the pressure sensor suitable to be fixed to the other members using the resistance welding can be manufactured efficiently.

For other points, the method for manufacturing the component of the pressure sensor according to the first modified example are similar to the method for manufacturing the component of the pressure sensor (see FIG. 9A to FIG. 9D) according to the above-mentioned embodiment (the left part of FIG. 8). The method for manufacturing according to the first modified example exhibits the similar effects as in the case of the method for manufacturing the component of the pressure sensor shown in the above-mentioned embodiment.

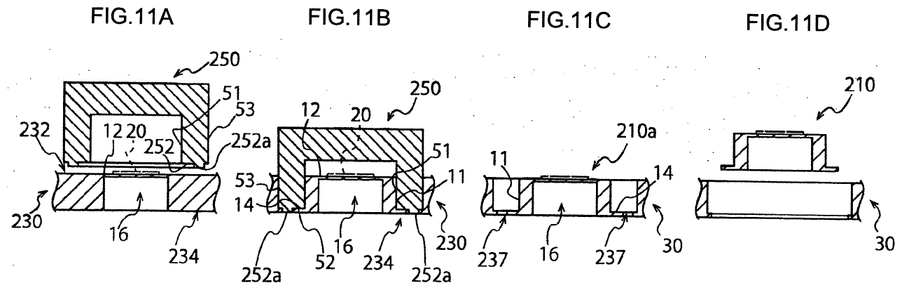

FIG. 11A to FIG. 11D are the conceptual figures showing the second modified example of the method for manufacturing the component of the pressure sensor according to the present disclosure. The method for manufacturing according to the second modified example is also basically similar to the method for manufacturing shown in the left part of FIG. 8. However, as discussed later, the method for manufacturing according to the second modified example has a difference in the main body machining step (including the separating step) (Step S004), and the groove forming step (Step S002) performed from the back side of the metal plate can be skipped. FIG. 11A to FIG. 11D are the conceptual figures showing the third electrode 250 and the metal plate 230 which is an object to be machined used in the main body machining step (Step S004) of the method for manufacturing according to the second modified example.

As shown in FIG. 11A which is the first state of the main body machining step (Step S004), the third electrode 250 used in the main body machining step according to the second modified example has a lower side protrusion 252a which protrudes towards the lower side from a bottom surface 252. The lower side protrusion 252a has a ring-like shape. The second inner cylindrical surface 51 and the second outer cylindrical surface 53 of the third electrode 250 are similar to the third electrode 50 shown in FIG. 10A, etc. Further, regarding the metal plate 230 which is the object to be machined during the main body machining step (Step S004), the groove is not formed to the back surface 234 which is different from the case of the metal plate 30 shown in FIG. 10A. That is, the groove forming step (Step S002) shown in FIG. 8 is not performed in the method for manufacturing the component of the pressure sensor according to the second modified example.

Next, as shown in FIG. 11B which is the second state, in the main body machining step (Step S004) of the method for manufacturing according to the second modified example, the lower side protrusion 252a of the third electrode 250 reaches the back surface 234 of the metal plate 230. Thereby, in the main body machining step according to the second modified example, due to the die sinking electrical discharge machining performed from the front surface 232 side of the metal plate 230 using the third electrode 250, a penetrating part 237 connecting from the front surface 232 to the back surface 234 of the metal plate 230 is formed.

As understood from FIG. 11C showing the metal plate 230 which is after the machining using the third electrode 250 (the third state), in the main body machining step according to the second modified example, due to the main body machining step which machines from the front surface 232 side of the metal plate 230 (or continuously from the main body machining step), a main body 210a is separated from the metal plate 230. That is, the main body machining step using the third electrode 250 in the second modified example can concurrently perform the separating step which separates the main body 210a from the metal plate 230. FIG. 11D shows the fourth step which the main body 210a after the separating step being taken out.

Also, as understood from FIG. 11A and FIG. 11B, in the method for manufacturing according to the second modified example, the groove forming step (Step S002) shown in FIG. 8 is not necessarily required; thus, the manufacturing steps can be simplified, and time needed for manufacturing can be shortened.

For other points, the method for manufacturing the component 210 of the pressure sensor according to the second modified example is similar to the method for manufacturing the component of the pressure sensor (see FIG. 9A to FIG. 9D) according to the above-mentioned embodiment (the left part of FIG. 8); and, the method for manufacturing according to the second modified example exhibits the similar effects as in the case of the method for manufacturing the component of the pressure sensor shown in the above-mentioned embodiment.

FIG. 12A to FIG. 12E are the conceptual figures showing the third modified example of the method for manufacturing the component of the pressure sensor according to the present disclosure. The method for manufacturing according to the third modified example is basically similar to the method for manufacturing shown in the right part of FIG. 8. However, as discussed later, the method for manufacturing according to the third modified example has a difference in the separating step (Step S005), since the die sinking electrical discharge machining is performed instead of the wire electrical discharge machining. FIG. 12A and FIG. 12B are the conceptual figures showing the third electrode 50 and the metal plate 230 which is an object to be machined used in the main body machining step (Step S004) of the method for manufacturing according to the third modified example. Also, FIG. 12C to FIG. 12E are the conceptual figures showing a fourth electrode 365 and the metal plate 230 which is an object to be machined in the separating step (Step S005) of the method for manufacturing according to the third modified example.

As shown in FIG. 12A which is the first state of the main body machining step (Step S004), the third electrode 50 used in the main body machining step according to the third modified example is similar to the third electrode 50 shown in FIG. 9A. Further, regarding the metal plate 230 which is the object to be machined during the main body machining step (Step S004), the groove is not formed to the back surface 234 side which is similar to the case of the metal plate 230 shown in FIG. 11A. That is, the groove forming step (Step S002) shown in the right part of FIG. 8 is not performed in the method for manufacturing the component of the pressure sensor according to the third modified example.

As shown in FIG. 12B which is the second state, in the main body machining step (Step S004) of the method for manufacturing according to the third modified example, the main body 10a which includes the first outer cylindrical surface 11 and the flange upper surface 14 is formed to the metal plate 230 by the die sinking electrical discharge machining using the third electrode 50. Note that, in the main body machining step (Step S004), the third electrode 50 does not penetrate the metal plate 230.

As shown in FIG. 12C which is the first state of the separating step (Step S005), in the separating step according to the third modified example, the wire electrical discharge machining shown in FIG. 6A and FIG. 6B is not performed, but the die sinking electrical discharge machining using the fourth electrode 365 is performed. As shown in FIG. 12C, the fourth electrode 365 used in the die sinking electrical discharge machining of the separating step (Step S005) includes a lower side protrusion 365a of a ring-like shape having a smaller area than the bottom surface 52 of the third electrode 50.

As shown in FIG. 12D which is the second state of the separating step (Step S005), in the separating step according to the third modified example, the die sinking electrical discharge machining is performed using the fourth electrode 365 from the front surface 232 side of the metal plate 230 to which the main body 10a is formed. During the separating step according to the third modified example, the lower side protrusion 365a of the fourth electrode 365 reaches the back surface 234 of the metal plate 230, and the penetrating part connecting from the front surface 232 to the back surface 234 of the metal plate 230 is formed. Thereby, the main body 10a is separated from the metal plate 230. FIG. 12E is the third state which shows the main body 10a being taken out after the separating step.

As shown in FIG. 12A to FIG. 12E, in the method for manufacturing according to the third modified example, the die sinking electrical discharge machining performed from the front surface 232 side, and the main body machining step (Step S004) and the separating step (Step S005) respectively uses different electrodes. According to such manufacturing method, the electrode used for the separating step (Step S005) can approach closer to the metal plate 230 from the same direction as the electrode used for the main body machining step (Step S004). Thus, the metal plate 230 and the main body 10a which is separated from the metal plate 230 can be held easily during the manufacturing steps. For other points, the method for manufacturing the component of the pressure sensor according to the third modified example are similar to the method for manufacturing the component of the pressure sensor according to the above-mentioned embodiment (the right part of FIG. 8). The method for manufacturing according to the third modified example exhibits the similar effects as in the case of the method for manufacturing the component of the pressure sensor shown in the above-mentioned embodiment.

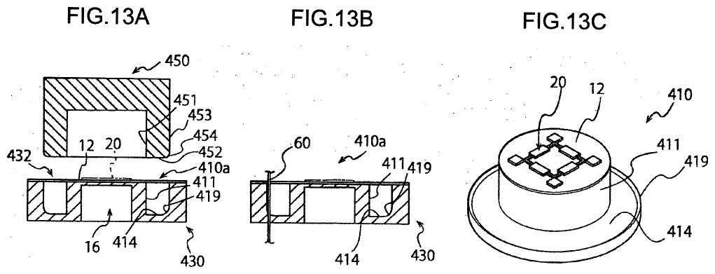

FIG. 13A to FIG. 13C are the conceptual figures showing the fourth modified example of the method for manufacturing the component of the pressure sensor according to the present disclosure. The method for manufacturing according to the fourth modified example is basically similar to the method for manufacturing shown in the right part of FIG. 8; however, as discussed later, in the method for manufacturing according to the fourth modified example, the shape of a third electrode 450, etc., used in the main body machining step (not including the separating step) are different from that of the third electrode 50 shown in FIG. 5A and FIG. 5B. FIG. 13A is the conceptual figure showing the third electrode 450 and the metal plate 430 to which the main body 410a is formed using the third electrode 450 used in the main body machining step (Step S004) of the method for manufacturing according to the fourth modified example. Also, FIG. 13B is a conceptual figure showing the wire 60 and the metal plate 430 which is an object to be machined during the separating step (Step S005) performed in the method for manufacturing according to the fourth modified example. Also, FIG. 13C is a perspective figure of a component 410 of the pressure sensor manufactured using the method for manufacturing according to the fourth modified example.

As shown in FIG. 13A, the third electrode 450 used in the main body machining step according to the fourth modified example includes a second inner cylindrical surface 451 and a bottom surface 452 which connects to the lower end of the second inner cylindrical surface 451, and the bottom surface 452 being positioned outside of a second inner cylindrical surface 451 in a radial direction. The bottom surface 452 extends in a radial direction of the second inner cylindrical surface 451. Also, the third electrode 450 includes the second outer cylindrical surface 453 positioned outside of the second inner cylindrical surface 451 in the radial direction.

The bottom surface 452 connects to the second outer cylindrical surface 453 at the lower end of the second outer cylindrical surface 453 via a connecting surface 454. The connecting surface 454 has an R-shape. In the main body machining step, using such third electrode 450, the die sinking electrical discharge machining is performed to the metal plate 430 from the front surface 432 side of the metal plate 430, and the main body 410a is formed to the metal plate 430. The main body 410a includes the first outer cylindrical surface 411 facing the second inner cylindrical surface 451. Also, the main body 410a includes a flange upper surface 414 facing the bottom surface 452 of the third electrode 450. Further, the main body 410a includes a flange outer circumference inclined surface 419 which is formed to the metal plate 430 and faces the connecting surface 454 of the third electrode 450.

As shown in FIG. 13B, the separating step (Step S005) is performed using the wire electrical discharge machining in the method for manufacturing according to the fourth modified example. For the wire electrical discharge machining performed in the separating step of the fourth modified example, the wire 60 used for the wire electrical discharge machining is moved in relativity to the metal plate 430 in the circumference direction along the flange outer circumference inclined surface 419. At this time, the wire 60 is arranged so that it crosses the flange outer circumference inclined surface 419 at the position outside than the inner circumference of the flange outer circumference inclined surface 419. Thereby, the main body 410a is separated from the metal plate 430, and the component 410 of the pressure sensor as shown in FIG. 13C is obtained. At this time, part of the flange outer circumference inclined surface 419 (the machined end of the flange outer circumference inclined surface 419 formed using the wire electrical discharge machining) configures the outer circumference of the main body 410a.

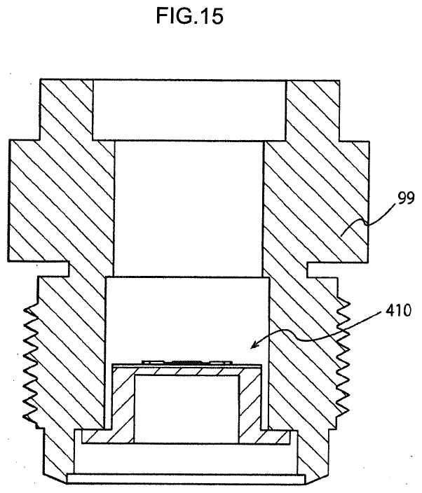

As shown in FIG. 13C, the component 410 of the pressure sensor has the flange outer circumference inclined surface 419 which protrudes upwards from the outer circumference edge of the flange upper surface 414. The flange outer circumference inclined surface 419 configures the ring-like protruding part formed along the outer circumference edge of the flange upper surface 14. At least part of the flange outer circumference inclined surface 419 suitably functions as a welding margin when the flange part of the pressure sensor is fixed to an other component 99 using the resistance welding in later stage (see FIG. 15). Therefore, according to such method for manufacturing, the component 410 of the pressure sensor which is suitable to be fixed to other components using the resistance welding can be manufactured efficiently. The method for manufacturing the component of the pressure sensor according to the fourth modified example is similar to the method for manufacturing the component of the pressure sensor according to the embodiment shown in the right part of FIG. 8; except that, the third electrode used for the main body machining step (not including the separating step) and the wire path during the separating step are different. For the common parts, the method for manufacturing according to the fourth modified example exhibits the similar effects as in the case of the method for manufacturing the component of the pressure sensor shown in the above-mentioned embodiment.

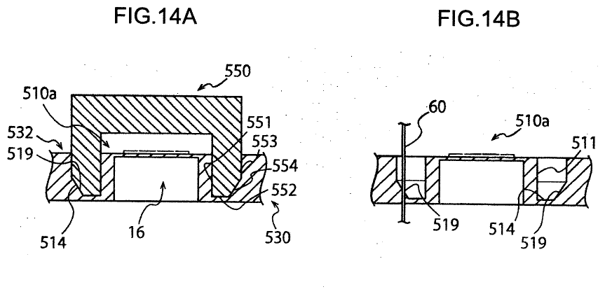

FIG. 14A and FIG. 14B are the conceptual figures showing the fifth modified example of the method for manufacturing the component of the pressure sensor according to the present disclosure. The method for manufacturing according to the fifth modified example is basically similar to the method for manufacturing shown in the right part of FIG. 8; however, as discussed later, in the method for manufacturing according to the fifth modified example, the shape of a third electrode 550, etc., used in the main body machining step (not including the separating step) are different from those of the third electrode 50 shown in FIG. 5A and FIG. 5B. FIG. 14A is a conceptual figure showing the third electrode 550 and a metal plate 530 to which the main body 510a is formed using the third electrode 550 during the main body machining step (Step S004) of the method for manufacturing according to the fifth modified example. Also, FIG. 14B is a conceptual figure showing the wire 60 and the metal plate 530 which is an object to be machined in the separating step (Step S005) performed in the method for manufacturing according to the fifth modified example.

As shown in FIG. 14A, the third electrode 550 used in the main body machining step according to the fifth modified example includes a second inner cylindrical surface 551 and a bottom surface 552 connecting to the lower end of the second inner cylindrical surface 551, and the bottom surface 552 being positioned outside in a radial direction of the second inner cylindrical surface 551. The bottom surface 552 extends in a radial direction of the second inner cylindrical surface 551. Also, the third electrode 550 includes a second outer cylindrical surface 553 positioned outside in the radial direction of the second inner cylindrical surface 551.

The bottom surface 552 connects to the second outer cylindrical surface 553 at the lower end of the second outer cylindrical surface 553 via the connecting surface 554. The connecting surface 554 has a chamfered shape. In the main body machining step, using such third electrode 550, the die sinking electrical discharge machining is performed to the metal plate 530 from the front surface 532 side of the metal plate 530 to form the main body 510a to the metal plate 530. The main body 510a includes a first outer cylindrical surface 511 facing the second inner cylindrical surface 551 of the third electrode 550. Also, the main body 510a includes a flange upper surface 514 facing the bottom surface 552 of the third electrode 550. Further, the main body 510a includes a flange outer circumference inclined surface 519 which is formed to the metal plate 530 and faces the connecting surface 554 of the third electrode 550.

As shown in FIG. 14B, the separating step (Step S005) is carried out using the wire electrical discharge machining in the method for manufacturing according to the fifth modified example. For the wire electrical discharge machining performed in the separating step of the fifth modified example, the wire 60 used for the wire electrical discharge machining moves in relativity to the metal plate 530 in the circumference direction along the flange outer circumference inclined surface 519. At this time, the wire 60 is arranged so that it crosses the flange outer circumference inclined surface 519 at the position outside than the inner edge of the flange outer circumference inclined surface 519. Thereby, the main body 510a is separated from the metal plate 530, and the component of the pressure sensor is obtained. At this time, a part of the flange outer circumference inclined surface 519 (the machined end of the flange outer circumference inclined surface 519 formed using the wire electrical discharge machining) configures the outer edge of the main body 510a.

The component of the pressure sensor obtained by the method for manufacturing according to the fifth modified example is similar to the method for manufacturing the component 410 of the pressure sensor except that the flange outer circumference inclined surface 519 of the component of the pressure sensor of the fifth modified example is a flat surface, and the flange outer circumference inclined surface 419 of the component 410 of the pressure sensor is a curved surface (see FIG. 13C). Also, the method for manufacturing the component of the pressure sensor according to the fifth modified example is similar to the method for manufacturing the component of the pressure sensor according to the fourth modified example (see FIG. 13A to FIG. 13C) except that the shape of the connecting surface 554 of the third electrode 550 is different; and the method for manufacturing according to the fifth modified example exhibits the similar effects as in the case of the method for manufacturing the component of the pressure sensor according to the fourth modified example.

### Notes

As is understood from the above description, the present specification discloses the following.
[1] A method for manufacturing a metal component of a pressure sensor, the component including:
   a first outer cylindrical surface,
a cylinder upper surface connected to an upper end of the first outer cylindrical surface and positioned inside in a radial direction of the first outer cylindrical surface, and
   a flange upper surface connected to a lower end of the first outer cylindrical surface and positioned outside in the radial direction of the first outer cylindrical surface; and
   the method including:
a main body machining step performing a die sinking electrical discharge machining to a metal plate from a front side using an electrode comprising a second inner cylindrical surface and a bottom surface connected to a lower end of the second inner cylindrical surface, and the bottom surface being positioned outside in a radial direction of the second inner cylindrical surface so that the metal plate has the first outer cylindrical surface facing the second inner cylindrical surface and the flange upper surface facing the bottom surface; and
a separating step separating a main body at least including a part corresponding to the first outer cylindrical surface and the flange upper surface from the metal plate using an electrical discharge machining.
[2] The method for manufacturing the component of the pressure sensor according to [1] further including a groove forming step, prior to the main body machining step, performing a die sinking electrical discharge machining from a back side of the metal plate to form a ring-like groove,
wherein, the die sinking electrical discharge machining is performed from the front side of the metal plate using the electrode to form a penetrating part connecting to the groove from the front surface of the metal plate during the main body machining step, and the main body machining step includes the separating step.
[3] The method for manufacturing the component of the pressure sensor according to [2], wherein the electrode used in the main body machining step has a second outer cylindrical surface at outside in a radial direction of the second inner cylindrical surface, and the bottom surface connects to the second outer cylindrical surface via a connecting surface at a lower end of the second outer cylindrical surface; and the connecting surface reaches the groove to form the penetrating part during the main body machining step.
[4] The method for manufacturing the component of the pressure sensor according to [1], wherein the electrode used in the main body machining step has a lower side protrusion protruding toward a lower side from the bottom surface, and the lower side protrusion reaches a back surface of the metal plate during the main body machining step to form a penetrating part connecting to the back surface from the front side of the metal plate, and the main body machining step includes the separating step.
[5] The method for manufacturing the component of the pressure sensor according to [1] further including a cavity forming step forming a cavity on a back surface of the metal plate using a die sinking electrical discharge machining from the back surface of the metal plate at a position corresponding to the cylinder upper surface of the front surface of the metal plate.
[6] The method for manufacturing the component of the pressure sensor according to [1] further including a piezoresistive film forming step forming a piezoresistive film at a position corresponding to the cylinder upper surface of the front surface of the metal plate prior to the main body machining step.
[7] The method for manufacturing the component of the pressure sensor according to [1], wherein the separating step is performed using a wire electrical discharge machining after the main body machining step.
[8] The method for manufacturing the component of the pressure sensor according to [7], wherein the electrode used in the main body machining step has a second outer cylindrical surface at outside in a radial direction of the second inner cylindrical surface, and the bottom surface connects to the second outer cylindrical surface via a connecting surface at a lower end of the second outer cylindrical surface, and
during the wire electrical discharge machining performed in the separating step, a wire for the wire electrical discharge machining is moved in relativity to the metal plate along a flange outer circumference inclined surface formed on the metal plate facing the connecting surface during the main body machining step to separate the main body from the metal plate so that the flange outer circumference inclined surface partially forms an outer edge of the main body.
[9] The method for manufacturing the component of the pressure sensor according to [1], wherein the separating step is performed using a die sinking electrical discharge machining after the main body machining step.
[10] The method for manufacturing the component of the pressure sensor according to [9], wherein an electrode used for the die sinking electrical discharge machining in the separating step comprises a lower side protrusion reaching to a back surface of the metal plate during the separating step to form a penetrating part connecting to the back surface from the front side of the metal plate.

### REFERENCE SIGNS LIST

10, 110, 210, 410 . . . Component of pressure sensor
11, 411, 511 . . . First outer cylindrical surface
12 . . . Cylinder upper surface
13 . . . Flange side surface
14, 414, 514 . . . Flange upper surface
15 . . . Flange lower surface
16 . . . Cavity
17 . . . Cavity side surface
18 . . . Cavity upper base surface
119, 419, 519 . . .Flange outer circumference inclined surface
20 . . . Piezoresistive film
10a, 210a, 410a, 510a . . . Main body
30, 230, 430 . . . Metal plate
32, 232 . . . Front surface
34, 234 . . . Back surface
35 . . . Groove
36 . . . Insulation film
137, 237 . . . Penetrating
41 . . . First electrode
41a . . . Circular cylinder-shape part
42 . . . Second electrode
42a . . . Ring-like protrusion
50, 150, 250, 450, 550 . . . Third electrode
50a . . . Ring-like protruding part
51, 451, 551 . . . Second inner cylindrical surface
52, 152, 252, 452, 552 . . . Bottom surface
53, 153, 453, 553 . . . Second outer cylindrical surface
60 . . . Wire
62 . . . Cutting path
63 . . . Second cutting path
θ1 . . . Angle
θ2 . . . Angle
154, 454, 554 . . . Connecting surface
252a, 365a . . . Lower side protrusion
365 . . . Fourth electrode

What is claimed is:

1. A method for manufacturing a metal component of a pressure sensor, the component comprising
a first outer cylindrical surface,
a cylinder upper surface connected to an upper end of the first outer cylindrical surface and positioned inside in a radial direction of the first outer cylindrical surface, and
a flange upper surface connected to a lower end of the first outer cylindrical surface and positioned outside in the radial direction of the first outer cylindrical surface; and
the method comprising:
a main body machining step performing a die sinking electrical discharge machining to a metal plate from a front side using an electrode comprising a second inner cylindrical surface and a bottom surface connected to a lower end of the second inner cylindrical surface, and the bottom surface being positioned outside in a radial direction of the second inner cylindrical surface so that the metal plate has the first outer cylindrical surface facing the second inner cylindrical surface and the flange upper surface facing the bottom surface; and
a separating step separating a main body at least including a part corresponding to the first outer cylindrical surface and the flange upper surface from the metal plate using an electrical discharge machining.

2. The method for manufacturing the component of the pressure sensor according to claim 1 further comprising a groove forming step, prior to the main body machining step, performing a die sinking electrical discharge machining from a back side of the metal plate to form a ring-like groove,
wherein, the die sinking electrical discharge machining is performed from the front side of the metal plate using the electrode to form a penetrating part connecting to the groove from the front surface of the metal plate during the main body machining step, and the main body machining step includes the separating step.

3. The method for manufacturing the component of the pressure sensor according to claim 2, wherein the electrode used in the main body machining step has a second outer cylindrical surface at outside in a radial direction of the second inner cylindrical surface, and the bottom surface connects to the second outer cylindrical surface via a connecting surface at a lower end of the second outer cylindrical surface; and
the connecting surface reaches the groove to form the penetrating part during the main body machining step.

4. The method for manufacturing the component of the pressure sensor according to claim 1, wherein the electrode used in the main body machining step has a lower side protrusion protruding toward a lower side from the bottom surface, and the lower side protrusion reaches a back surface of the metal plate during the main body machining step to form a penetrating part connecting to the back surface from the front side of the metal plate, and the main body machining step includes the separating step.

5. The method for manufacturing the component of the pressure sensor according to claim 1 further comprising a cavity forming step forming a cavity on a back surface of the metal plate using a die sinking electrical discharge machining from the back surface of the metal plate at a position corresponding to the cylinder upper surface of the front surface of the metal plate.

6. The method for manufacturing the component of the pressure sensor according to claim 1 further comprising a piezoresistive film forming step forming a piezoresistive film at a position corresponding to the cylinder upper surface of the front surface of the metal plate prior to the main body machining step.

7. The method for manufacturing the component of the pressure sensor according to claim 1, wherein the separating step is performed using a wire electrical discharge machining after the main body machining step.

8. The method for manufacturing the component of the pressure sensor according to claim 7, wherein the electrode used in the main body machining step has a second outer cylindrical surface at outside in a radial direction of the second inner cylindrical surface, and the bottom surface connects to the second outer cylindrical surface via a connecting surface at a lower end of the second outer cylindrical surface, and
during the wire electrical discharge machining performed in the separating step, a wire for the wire electrical discharge machining is moved in relativity to the metal plate along a flange outer circumference inclined surface formed on the metal plate facing the connecting surface during the main body machining step to separate the main body from the metal plate so that the flange outer circumference inclined surface partially forms an outer edge of the main body.

9. The method for manufacturing the component of the pressure sensor according to claim 1, wherein the separating step is performed using a die sinking electrical discharge machining after the main body machining step.

10. The method for manufacturing the component of the pressure sensor according to claim 9, wherein an electrode used for the die sinking electrical discharge machining in the separating step comprises a lower side protrusion reaching to a back surface of the metal plate during the separating step to form a penetrating part connecting to the back surface from the front side of the metal plate.
